(19) United States
(12) Patent Application Publication
(10) Pub. No.: US 2026/0146961 A1
(43) Pub. Date: May 28, 2026

(54) X-RAY SYSTEM AND CT SYSTEM

(71) Applicant: Fraunhofer-Gesellschaft zur Förderung der angewandten Forschung e.V., München (DE)

(72) Inventors: Michael SALAMON, Erlangen (DE); Nils REIMS, Erlangen (DE); Michael BÖHNEL, Erlangen (DE); Dimitri PRJAMKOV, Nürnberg (DE); Sven KILIAN, Nürnberg (DE)

(73) Assignee: Fraunhofer-Gesellschaft zur Förderung der angewandten Forschung e.V., München (DE)

(21) Appl. No.: 19/452,814

(22) Filed: Jan. 19, 2026

Related U.S. Application Data
(63) Continuation of application No. PCT/EP2024/070315, filed on Jul. 17, 2024.

(30) Foreign Application Priority Data
Jul. 19, 2023 (DE) 102023206858.3

(51) Int. Cl. G01N 23/18; G01N 23/046; G01N 23/083

(52) U.S. Cl. CPC G01N 23/18; G01N 23/046; G01N 23/083; G01N 2223/645; G01N 2223/646

(57) ABSTRACT

X-ray system for examining N objects, in particular N battery modules for quality testing, comprising: a linear accelerator configured to emit X-ray radiation with an energy ≥1 MeV at a cone-shaped emission angle; N X-ray detectors that are each configured to detect the X-ray radiation in a partial cone of the cone-shaped emission angle; N rotational axes and for N objects that are each assigned to a partial cone and that are arranged in each one; a collimator configured in two stages, wherein a first stage defines the cone-shaped emission angle at which the X-ray radiation is emitted and wherein a second stage defines the N partial cones.

### CROSS-REFERENCES TO RELATED APPLICATIONS

This application is a continuation of copending International Application No. PCT/EP2024/070315, filed Jul. 17, 2024, which is incorporated herein by reference in its entirety, and additionally claims priority from German Application No. 102023206858.3, filed Jul. 19, 2023, which is incorporated herein by reference in its entirety.

### BACKGROUND OF THE INVENTION

Embodiments of the present invention relate to an X-ray system and to a CT system. Further embodiments relate to a method for operating the X-ray system and to a method for operating the CT system. Further embodiments relate to a corresponding computer program. In general, the embodiments of the invention are in the field of high-throughput computer tomography for quality assurance of vehicle battery modules. Advantageous embodiments provide an X-ray system or computer tomography system with a linear accelerator and a multiple-beam arrangement.

The production of battery modules for electromobility applications places high demands on the quality of the internal module structure. Therefore, in the development of such energy storages, computer tomography examinations that make the internal structure visible and thus allow different quality parameters to be detected are carried out. These CT methods are generally based on an X-ray tube and a planar X-ray detector that detects the X-ray shadow of the battery module to be examined. In this case, the battery module is rotated in the beam by means of a rotational axis and thus detected from a multitude of viewing directions. Following the scan, the projection data thus obtained is offset by means of a mathematical reconstruction operation to form a volume that allows the evaluation of the module quality.

The X-ray technology used for this purpose usually has only a limited radiation energy, which often leads to an inadequate image quality in the reconstructed volume and thus limits the reliability of the evaluation. In principle, if high reliability is required, the costs for quality assurance are enormously high. Thus, there is a need for an improved approach.

### SUMMARY

An embodiment may have a X-ray system for examining N objects, in particular N battery modules for quality testing, comprising: a linear accelerator configured to emit X-ray radiation with an energy ≥1 MeV at a cone-shaped emission angle; N X-ray detectors that are each configured to detect the X-ray radiation in one of N partial cones, that are separated from one another, of the cone-shaped emission angle; at least N rotational axes and for N objects that are each assigned to one of the N partial cones separated from one another and that are arranged in each one; a collimator configured in two stages, wherein a first stage defines the cone-shaped emission angle at which the X-ray radiation is emitted and wherein a second stage defines the N partial cones separated from one another and divides the N partial cones separated from one another such that the N partial cones separated from one another are separated by one or more shadow cones located therebetween.

Another embodiment may have a CT system comprising an X-ray system according to the invention and a CT calculation unit, wherein the CT calculation unit is configured to carry out the CT reconstruction for the N objects independently of one another.

Another embodiment may have a method for operating an X-ray system according to the invention, wherein the method comprises forming N partial cones for the irradiation of N objects.

Another embodiment may have a non-transitory digital storage medium having a computer program stored thereon to perform the method for operating an X-ray system according to the invention, wherein the method comprises forming N partial cones for the irradiation of N objects, when said computer program is run by a computer.

Embodiments of the present invention provide an X-ray system for examining N objects, such as battery modules. Thus, N battery modules can be examined for quality testing by means of an X-ray system. The X-ray system comprises a linear accelerator configured to emit X-rays with an energy >1 MeV at a cone-shaped emission angle, e.g. 25°or even 180° and generally any desired angle. Furthermore, the X-ray system has N X-ray detectors that are each configured to detect the X-rays in a partial cone of the cone-shaped emission angle. In each case, one of at least N axes of rotation for the at least N objects is assigned to one of the partial cones and is also arranged in each partial cone. According to embodiments, the arrangement of the rotational axis, which can comprise an object holder for the at least N objects, is arranged between the linear accelerator and the respective one of the N X-ray detectors. Furthermore, the X-ray system comprises a collimator configured in two stages, wherein a first stage forms or defines the cone-shaped emission angle and a second stage defines the N partial cones.

Embodiments of the present invention are based on the knowledge that, by using N X-ray detectors, N objects may be examined or irradiated in N partial cones that are separated from one another, e.g. for quality assurance. The N partial cones result from a cone-shaped X-ray spectrum emitted by a linear accelerator. The separate examination or subsequent simultaneous examination of the N objects takes place in that a separate rotational axis is provided for each object. The advantage of this arrangement is that the most cost-intensive component may be used not only for the irradiation of an object, but for the irradiation of a series of objects or generally of a plurality of objects. This increases the throughput and thus also the investment costs per object to be examined. The collimator splitting the X-ray radiation onto the partial cones in this case advantageously images the high-energy X-ray radiation >1 MeV such that no disadvantages occur with respect to the emission of only one total cone.

According to embodiments, the N X-ray detectors are configured as line detectors or advantageously as area detectors. According to embodiments, each of the N X-ray detectors may comprise its own detector electronics. According to further embodiments, it would also be conceivable for the electronics of at least two of the N detectors to be combined. It would also be possible for two adjacent X-ray detectors to overlap one another, namely such that the electronics form an overlap and thus the rear electronics are protected by the front electronics in the projection of the X-ray radiation. The advantage in this case is that the electronics are sensitive to X-rays and thus there is no need for separate means (or device) for protection against the X-ray radiation at least for the rear electronics. According to embodiments, the electronics comprise means for protection against X-ray radiation, e.g., an absorber arranged upstream in the X-ray cone. According to alternative embodiments, the electronics are arranged in a region protected against the X-ray radiation. According to advantageous embodiments, such a region may be formed by a shadow cone. For example, the electronics of the N X-ray detectors may be arranged between the partial cones. Alternatively, it would also be conceivable for the electronics to be arranged in a region shielded by one or more shielding elements. The one or more shielding elements may be arranged between the partial cones. According to further embodiments, it would also be conceivable for the electronics to be shielded by a respective shielding element either being part of the collimator (i.e. in a region between the linear accelerator and the object) and/or provided as a dedicated shielding element in a region between the object and the detector. According to further embodiments, the collimator may be configured to generate a shadow cone between the partial cones. For example, the electronics may be positioned in this shadow cone.

According to embodiments, the N X-ray detectors may be arranged linearly or circularly or elliptically (around the linear accelerator or the center point of the cone-shaped emission angle). An overlap may be provided both in the linear arrangement and in the circular arrangement. As already explained above, the overlap may be provided precisely in the region of the electronics of the respective detector elements.

According to embodiments, the rotational axis between the linear accelerator and the detector is arranged in a distance ratio of the distances from the linear accelerator to the rotational axis and from the rotational axis to the X-ray detector such that at least 75% or at least 95% of the object may be detected at the same time. Assuming, for example, a possible object size of 10×10 cm or 50×20 cm, the resulting arrangement and dimensioning of the object holder on the rotational axis are appropriate.

According to a further embodiment, it would also be conceivable for a stroke (or lifting) movement to be provided in addition to the rotational movement. In this respect, the rotational axis may be extended by an additional stroke axis, such that a stroke movement of the object also takes place together with or independently of one another in addition to the rotational movement.

A further embodiment provides a CT system with an X-ray system as described above and a CT calculation unit. This CT calculation unit carries out a reconstruction for the N objects independently of one another.

Further embodiments relate to a method for operating the X-ray system. The core element of the method is forming N partial cones for the irradiation of N objects. According to embodiments, forming may take place by the collimator and in particular the second stage of the collimator.

A further embodiment provides a method for operating the defined CT system. The method includes a step of processing a plurality of irradiation recordings per object, assigned to the different rotational angles, for example, to obtain a CT reconstruction per object. According to embodiments, the method may be computer-implemented.

### BRIEF DESCRIPTION OF THE DRAWINGS

Embodiments of the present invention will be detailed subsequently referring to the appended drawings, in which:

FIG. 1 shows a schematic representation of an X-ray system according to a basic embodiment;

FIG. 2 shows a schematic representation of an X-ray system according to an extended embodiment; and

FIG. 3 shows a schematic representation of an X-ray system according to the prior art.

### DETAILED DESCRIPTION OF THE INVENTION

Before embodiments of the present invention are explained below with reference to the accompanying drawings, it should be noted that elements and structures having the same effect are provided with the same reference signs so that their description may be applied to one another or may be interchanged.

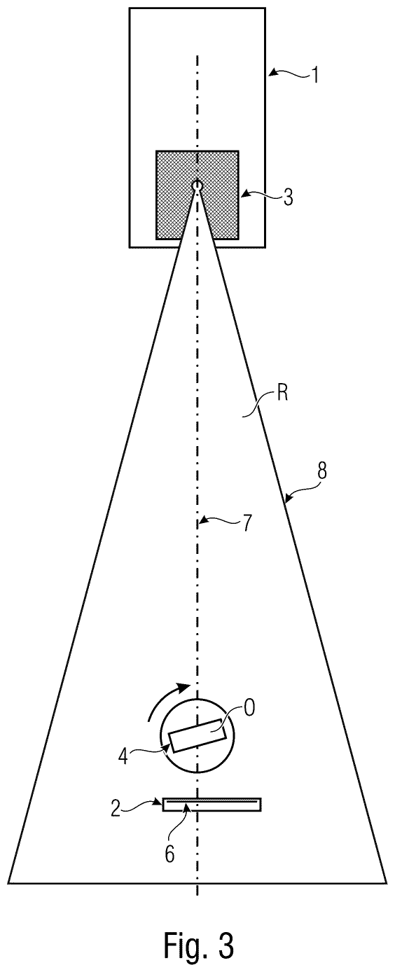

Before embodiments of the present invention are explained, the prior art is explained with reference to FIG. 3.

FIG. 3 shows an X-ray system with a radiation source 1 and a detector 2 as the central components. The radiation source may be a conventional X-ray tube or-according to embodiments of the invention-a linear accelerator configured to emit X-ray radiation R along an X-ray radiation cone 8. The X-ray radiation cone 8 may be delimited or defined by means of a collimator 3—same as it is applied in embodiments of the invention explained below. The X-ray radiation is emitted by the radiation source 1 along the central plane 7 so that a detector 2 (here the housing of the detector is illustrated schematically) may receive the X-ray radiation R. For this purpose, the X-ray detector comprises an layer 6 sensitive to X-ray radiation, but may also be implemented differently, e.g. using a scintillator.

A turntable is arranged between the X-ray source 1 and the X-ray detector 2. The turntable functions as an object holder. According to embodiments, the turntable may comprise an object holder. The turntable or the object holder is configured to hold the object O and to allow it to rotate when being held in order to carry out irradiation recordings from a plurality of object angles for a CT reconstruction. Consequently, the turntable 4 or the rotational axis 4 is configured to carry out a rotation, e.g. by 360°. With regard to the dimensioning, the turntable is adapted to the object O. According to advantageous applications, the object O is a battery, e.g. in the dimensioning 10×10 or 50×50, in a format with different lengths.

Battery modules have a high density so that it has been recognized that a particular combination of radiation source 1 and radiation detector 2 is advantageous. The following has been recognized by embodiments. Due to the high density in battery modules O, a linear accelerator with energies above 1 MeV is expedient for an optimal transillumination. Due to the fact that the acquisition and operating costs (e.g. expenses due to regular examination) are very high, a sufficiently good imaging quality may be achieved with the use of a linear accelerator, with the above-defined object of cost efficiency being missed.

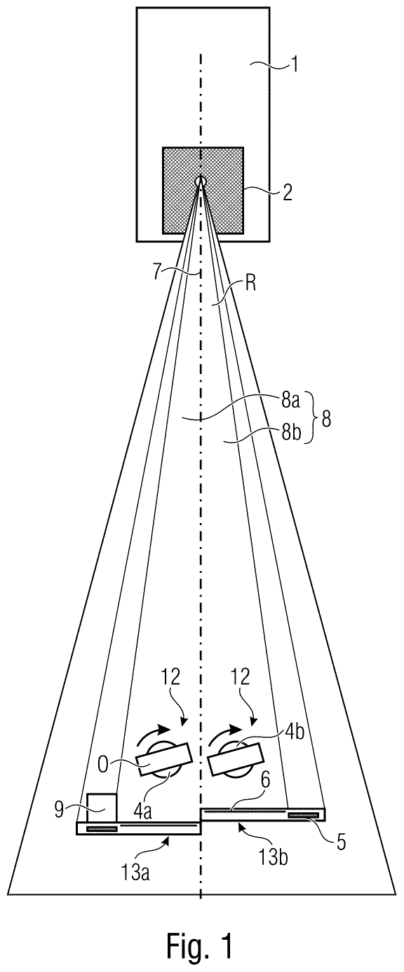

Embodiments of the present invention are based on the knowledge that, especially for the application on battery modules, with typical volume cross-sections between 10×10 cm and 50×20 cm and different lengths, the profitability may be significantly increased by the introduction of further beam axes, also called beam lines. According to embodiments, these beam axes consist of a separate X-ray detector and one or more rotational axes in the cone beam of the linear accelerator. In this case, the beam cone spanned by the linear accelerator is optimally used. This concept is explained below with reference to FIG. 1.

FIG. 1 shows an X-ray system with a radiation source 1, a collimator 3 and two detectors 13a and 13b.

The collimator 2 delimits the beam cone 8 in its outer contour and splits the beam cone 8 into two partial cones 8a and 8b. The beam cone 8a is received by the detector 13a while the beam cone 8b is received by the detector 13b. A respective turntable 4a or 4b for the corresponding objects O is provided in each beam cone 8a and 8b. With regard to the geometry, it should be noted that, according to embodiments, the turntables 4a and 4b are arranged in the respective beam cones 8a and 8b, specifically in the region between the radiation source 1 or the collimator 2 and the respective X-ray detector 13a or 13b. An imaging scale of the object O may be defined by the distance ratio of the distances from the radiation source 1 to the object holder 4a/4b and from the object holder 4a/4b to the detector 13a and 13b. According to embodiments, the imaging scale is selected such that a complete imaging of the object O is possible. After having explained the structure, the functionality is now explained. The linear accelerator emits X-ray radiation R with energies above 1 MeV at a cone-shaped emission angle (cf. beam cone 8). By rotating the objects O by means of the turntables 4a and 4b, a transillumination of a plurality of objects may take place simultaneously, i.e. parallel to one another, specifically in each case from different object angles, so that a CT reconstruction is possible. The respective detector 13a and 13b detects the transillumination images.

In this embodiment, two (N=2) object holders or turntables 4a and 4b are provided together with two (N=2) detectors 13a and 13b. Here, the detectors are arranged linearly next to one another, wherein, alternatively, a circular or elliptical arrangement, e.g. around the X-ray radiation source 1 or the focal spot of the X-ray radiation source 1, would also be conceivable. At this point, it should be noted that the number of detectors and the number of object carriers does not necessarily have to be the same. For example, two object carriers may also be used per detector.

According to embodiments, the detectors may be flat-panel detectors that may simultaneously detect the majority of the battery module O. As already explained above, the detection range is set via the distance ratio of the object carrier 4a or 4b with respect to the two elements 1 and 13a/13b.

According to embodiments, each X-ray detector 12a and 12b may comprise the sensitive detector area 6 and corresponding detector electronics 5 once. In the present case, the beam cone 8 is divided into two parts by the line 7 (central beam plane). According to embodiments, since the detector area 6 does not extend over the full width of the detector 13a or 13b, the rotational axis 4a or 4b may also be arranged decentrally in the respective partial cone 8a and 8b. Here, in each case, displaced towards the central beam plane 7. According to embodiments, at n=2, the detector electronics 5 may be arranged in the edge region of the X-ray beam cone 8 (outer edge of the X-ray beam cone 8 defined by the beam collimator 3). According to further embodiments, it would also be conceivable for the aperture angle of the X-ray beam cone 8 to be further restricted by the beam collimator 3, such that the electronics 5 are arranged in a sealed-off region, i.e. protected against the X-ray radiation R. According to further embodiments, it would also be conceivable for a so-called shielding block to be provided for protecting the detector electronics 5 against the X-ray radiation R. This shielding block is exemplarily provided in the region of the electronics 5 of the X-ray detector 13a and is provided with the reference sign 9.

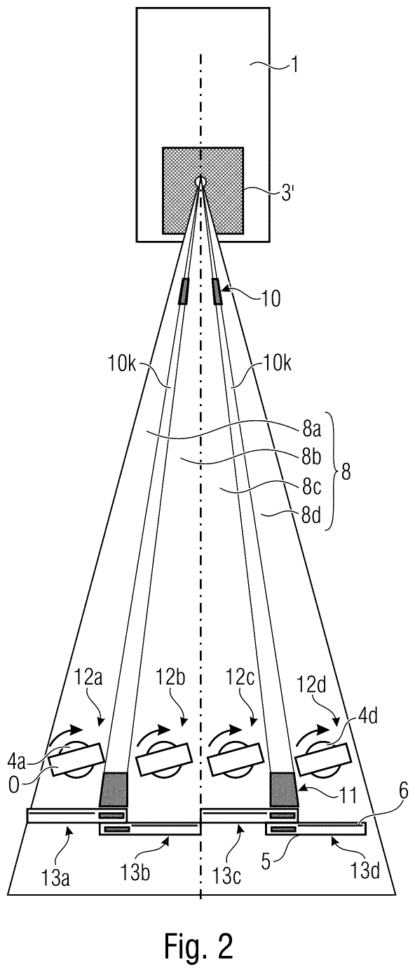

With reference to FIG. 2, a further embodiment is explained in which, in turn, N X-ray detectors 13a-13d and N rotational axes 4a-4d are provided in combination with the radiation source 1 or the collimator 3′. In this embodiment, N=4, i.e. four objects O may simultaneously be transilluminated by means of the four detectors 13a-13d. The four objects O are arranged on the respective rotational axes 4a-4d.

According to one embodiment, the detectors 13a and 13b are of partially overlapping design, as are the detectors 13c and 13d. In each case, the detector electronics 5 are provided in the overlap region, while the sensitive area 6 is provided in the non-overlapping region. According to one embodiment, precisely this overlap region, which overlaps in alignment as seen in the X-ray radiation direction, is provided with a specially shaped shielding block 11. This shielding block includes, for example, a shape adapted to the angle of incidence (for example, a cone shape). According to embodiments, the thickness is dependent on the energy of the X-ray radiation R to be expected, as well as dependent on the selected shielding material of the shielding block 11. In this embodiment, two shielding blocks 11 are provided, that is once in the overlap region 13a and 13b and once in the overlap region 13c and 13d.

Additionally or alternatively, the collimator 3′ may also be extended by an additional collimator for delimiting the cone beam to the additional detectors. This element is provided with the reference numeral 11 and forms a shadow cone 10k between the partial cones 8a, 8b, 8c and 8d. As can be seen, the shadow cone 10k is provided only between the cones 8a and 8b, as well as between the cones 8c and 8d. According to advantageous embodiments, the electronics 5 of the detector elements 13a, 13b, 13c and 13d are arranged precisely in this shadow cone 10k or in alignment with this shadow cone 10k. According to embodiments, the additional collimator element 10 may also be combined with the shielding block 11. With regard to the dimensioning, according to embodiments, these may be adapted to one another.

This means that, according to embodiments, one stage of the collimator divides the X-ray cone into several partial cones 8a, 8b, 8c and 8d and in this case correspondingly inserts one or more shadow cones 10k between two partial cones 8a and 8b. In this case, on the one hand, the good separation from the beam cones is advantageous so that a mutual influence in case of simultaneous measurements may be excluded and, on the other hand, also the above-mentioned possibility of positioning the electronics in this shadow cone.

At this point, it should be noted that the element 10 for delimiting the cone beam 8 may be referred to as the second stage of the collimator 3′. The first stage of the collimator delimits the cone beam to the side, while the second stage of the collimator 10 carries out a division of the cone beam into partial cone beams. With regard to the combination of collimator 3′ with an additional collimator element 10, it should be noted that a special beam collimator defining an optimal beam field for each detector-axis pair is formed in this way.

At this point, it should be noted that, due to the overlap of the detectors 13a and 13b or 13c and 13d, the distances of the detector areas 6 from the radiation source 1 may vary slightly. In order to ensure an imaging of the same size, according to embodiments, the distance of the respective rotational axis, for example 12c and 12d, may also vary slightly.

At this point, it should be noted that, in the simplest implementation, each detector may comprise a detector area (line-shaped or area-shaped). In a further configuration, each detector element 13a-13d comprises the corresponding electronics 5. According to embodiments, electronics for two sensitive areas 6 may also be combined if they are arranged, for example, centrally in the shielded region/shadow cone. Furthermore, according to embodiments, each detector element 13a-13d also comprises a corresponding detector housing.

In the above embodiments, it was assumed that the number N for the number of rotational axes is identical to the number of detectors. According to other embodiments, the number for the rotational axes may also be greater than N.

According to a further embodiment, it would be conceivable for a stroke axis to be provided in addition to the rotational axes 12a-12d, for example mounted below or on the rotational axis itself, in order also to carry out a stroke movement in addition to the rotational movement. This stroke movement may be carried out simultaneously with the rotational movement in order to allow a helical detection of the usually elongate battery modules O. As a result, the so-called Feldkamp artifacts are advantageously minimized. According to a further embodiment, the movement system may of course also be different, for example have a serial movement sequence.

With regard to the rotational movements of the rotational axes 12a-12d, it should be noted that these may rotate individually or also synchronously.

A further embodiment relates to a CT system in which a reconstruction unit (calculation unit) is provided, carrying out the CT reconstruction (volume calculation) on the basis of the plurality of irradiation recordings of the object O.

According to an embodiment, a method relates to the operation of the CT system with the central calculation step. According to an advantageous embodiment, this method may be computer-implemented.

A further embodiment relates to a method for operating the X-ray apparatus with the central step of splitting the beam cone into partial beam cones, for example with the aid of the collimator.

Even though some aspects have been described within the context of a device, it is understood that said aspects also represent a description of the corresponding method, so that a block or a structural component of a device is also to be understood as a corresponding method step or as a feature of a method step. By analogy therewith, aspects that have been described within the context of or as a method step also represent a description of a corresponding block or detail or feature of a corresponding device. Some or all of the method steps may be performed while using a hardware device, such as a microprocessor, a programmable computer or an electronic circuit. In some embodiments, some or several of the most important method steps may be performed by such a device.

Depending on specific implementation requirements, embodiments of the invention may be implemented in hardware or in software. Implementation may be effected while using a digital storage medium, for example a floppy disc, a DVD, a Blu-ray disc, a CD, a ROM, a PROM, an EPROM, an EEPROM or a FLASH memory, a hard disc or any other magnetic or optical memory which has electronically readable control signals stored thereon which may cooperate, or cooperate, with a programmable computer system such that the respective method is performed. This is why the digital storage medium may be computer-readable.

Some embodiments in accordance with the invention thus comprise a data carrier which comprises electronically readable control signals that are capable of cooperating with a programmable computer system such that any of the methods described herein is performed.

Generally, embodiments of the present invention may be implemented as a computer program product having a program code, the program code being effective to perform any of the methods when the computer program product runs on a computer.

The program code may also be stored on a machine-readable carrier, for example.

Other embodiments include the computer program for performing any of the methods described herein, said computer program being stored on a machine-readable carrier. In other words, an embodiment of the inventive method thus is a computer program which has a program code for performing any of the methods described herein, when the computer program runs on a computer. The data carrier, the digital storage medium, or the recorded medium are typically tangible, or non-volatile.

A further embodiment of the inventive methods thus is a data carrier (or a digital storage medium or a computer-readable medium) on which the computer program for performing any of the methods described herein is recorded.

A further embodiment of the inventive method thus is a data stream or a sequence of signals representing the computer program for performing any of the methods described herein. The data stream or the sequence of signals may be configured, for example, to be transferred via a data communication link, for example via the internet.

A further embodiment includes a processing means, for example a computer or a programmable logic device, configured or adapted to perform any of the methods described herein.

A further embodiment includes a computer on which the computer program for performing any of the methods described herein is installed.

A further embodiment in accordance with the invention includes a device or a system configured to transmit a computer program for performing at least one of the methods described herein to a receiver. The transmission may be electronic or optical, for example. The receiver may be a computer, a mobile device, a memory device or a similar device, for example. The device or the system may include a file server for transmitting the computer program to the receiver, for example.

In some embodiments, a programmable logic device (for example a field-programmable gate array, an FPGA) may be used for performing some or all of the functionalities of the methods described herein. In some embodiments, a field-programmable gate array may cooperate with a microprocessor to perform any of the methods described herein. Generally, the methods are performed, in some embodiments, by any hardware device. Said hardware device may be any universally applicable hardware such as a computer processor (CPU), or may be a hardware specific to the method, such as an ASIC.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCE NUMERALS

Object (O)
X-ray radiation (R)
Linear accelerator, radiation source with photon energies above 1 MeV (1)
X-ray detector outer housing (2)
Beam collimator of the linear accelerator for reducing housing transmission radiation (3, 3′)
Rotational axis with battery module to be examined (4) (12a, 12b, 12c, 12d) (4a, 4b)
Detector electronics (5)
Sensitive detector area (6)
Central beam plane (7)
Outer edge of the X-ray cone beam defined by beam collimator, emission angle (8)
Partial cones (8a, 8b, 8c, 8d)
Shielding block for protecting the detector electronics against radiation (9)
Additional beam collimators for delimiting the cone beam to the additional detectors, second stage (10)
X-ray detector (13a, 13b, 13c, 13d)
Specially shaped shielding blocks for protecting the detector electronics when using further beam axes, means for protection (11)
Additional rotational axes with in each case one battery module to be measured for increasing the throughput (12)
Additional detectors for increasing the throughput (13)

1. X-ray system for examining N objects, in particular N battery modules for quality testing, comprising:
a linear accelerator configured to emit X-ray radiation with an energy ≥1 MeV at a cone-shaped emission angle;
N X-ray detectors that are each configured to detect the X-ray radiation in one of N partial cones, that are separated from one another, of the cone-shaped emission angle;
at least N rotational axes and for N objects that are each assigned to one of the N partial cones separated from one another and that are arranged in each one;
a collimator configured in two stages, wherein a first stage defines the cone-shaped emission angle at which the X-ray radiation is emitted and wherein a second stage defines the N partial cones separated from one another and divides the N partial cones separated from one another such that the N partial cones separated from one another are separated by one or more shadow cones located therebetween.

2. X-ray system according to claim 1, wherein the N X-ray detectors are configured as line detectors or flat-panel detectors.

3. X-ray system according to claim 1, wherein each of the N X-ray detectors comprises electronics or wherein at least two of the N detectors comprise common electronics.

4. X-ray system according to claim 3, wherein the electronics are configured with a device for protection against X-ray radiation and/or wherein the electronics are arranged in a region protected against X-ray radiation.

5. X-ray system according to claim 3, wherein the N X-ray detectors are configured to be overlapping; or
wherein the N X-ray detectors are configured to be overlapping and the electronics of the N X-ray detectors are arranged in an overlap region.

6. X-ray system according to claim 3, wherein the electronics of the N X-ray detectors are arranged between the partial cones and/or in a region shielded by one or more shielding elements, wherein the one or more shielding elements are arranged between the partial cones; and/or
wherein the electronics are shielded by a shielding element either being part of the collimator and/or provided as a dedicated shielding element in a region between the object and the detector.

7. X-ray system according to claim 1, wherein the collimator is configured to generate a shadow cone between the partial cones or to generate a shadow cone for the arrangement of electronics between the partial cones.

8. X-ray system according to claim 1, wherein the rotational axis and between the linear accelerator and the respective detectors is arranged in a distance ratio of the distances from the linear accelerator to the rotational axis and and from the rotational axis and to the X-ray detector such that at least 75% or at least 95% of the object may be detected at the same time.

9. X-ray system according to claim 1, wherein the N X-ray detectors are arranged linearly or circularly or linearly overlapping or circularly within the cone-shaped emission angle.

10. X-ray system according to claim 1, wherein the rotational axes and are configured to be rotated individually and/or synchronously.

11. X-ray system according to claim 1, wherein the rotational axes and are extended by an additional stroke axis, such that a stroke movement of the object may take place together with or independently of a rotational movement.

12. X-ray system according to claim 1, wherein in the region of the shadow cones the radiation intensity is reduced in relation to the partial cones or is reduced by at least 50%.

13. X-ray system according to claim 12, wherein electronics are arranged in the shadow cone.

14. CT system comprising an X-ray system according to claim 1 and a CT calculation unit, wherein the CT calculation unit is configured to carry out the CT reconstruction for the N objects independently of one another.

15. Method for operating an X-ray system according to claim 1, wherein the method comprises forming N partial cones for the irradiation of N objects.

16. Method for operating a CT system according to claim 15, wherein the method comprises processing a plurality of irradiation recordings per object, assigned to different rotational angles.

17. Non-transitory digital storage medium having a computer program stored thereon to perform the method for operating an X-ray system according to claim 1, wherein the method comprises forming N partial cones for the irradiation of N objects, when said computer program is run by a computer.
